(19) United States
(12) Patent Application Publication
(10) Pub. No.: US 2012/0166526 A1
(43) Pub. Date: Jun. 28, 2012

(54) REQUEST FORWARDING AND RESULT AGGREGATING SYSTEMS, METHODS AND COMPUTER READABLE MEDIA

(76) Inventor: Amit Ashok Ambardekar, Ratnagiri (IN)

(21) Appl. No.: 13/335,944

(22) Filed: Dec. 23, 2011

Related U.S. Application Data
(60) Provisional application No. 61/427,300, filed on Dec. 27, 2010.

(51) Int. Cl. G06F 15/16

(52) U.S. Cl. 709/203

(57) ABSTRACT

Systems, methods and computer readable media for web request forwarding and result aggregating include a client-side forwarder that processes user requests and forwards the browser to a forwarding URL based on web request URL processing and user data processing. User data can remain private on the client system. Request aggregating can include processing a request to identify a plurality of URLs. Sending a processed request to the plurality of URLs. Obtaining results from the plurality of URLs and presenting the results in a single page for viewing by a user.

This application claims the benefit of U.S. Provisional Application No. 61/427,300, entitled “Privacy Safe And Fast Web Request Forwarder For Efficient Routing And Preprocessing Of Client Request” and filed on Dec. 27, 2010, the contents of which is incorporated herein by reference in its entirety.

Embodiments relate generally to request forwarding and result aggregating, and, more particularly, to systems, methods and computer readable media for forwarding web requests and aggregating results of web requests.

Conventional web request forwarding systems may accept a user search request and forward the search request to a search engine forwarder service after some processing. Conventional forwarding system may require that a new uniform resource locator (URL) be generated, which can involve network delay that may be on the order of hundreds of milliseconds. Further, because conventional system may change the URL for each request, caching cannot be effectively employed. Also, because an external server may be performing the forwarding operation, user data may need to be sent to the external server, which can present a privacy issue.

Embodiments have been conceived in light of the above-mentioned problems and limitations, among other things.

An embodiment can include a system for forwarding web requests having a client system with a processor coupled to a computer readable data storage device. The data storage device can have program instructions stored therein that, when executed by the processor, cause the processor to perform operations. The operations can include providing a user interface page for obtaining a web request for a first resource residing on a system external to the client system and obtaining a uniform resource locator (URL) from the web request. The operations can also include retrieving a URL fragment from the URL and processing the URL fragment.

The operations can further include obtaining user data from the web request and processing the user data. The operations can also include constructing a forwarding URL and directing a web browser program to the forwarding URL, the forwarding URL constructed to access a second resource from a system external to the client system.

User data can remain within the client system and not be transmitted to a system external to the client system. Processing of the user data can include processing the user data with a client-side script.

The operations can further include enabling caching on a forwarder page such that requests within a predetermined time period do not create a new hypertext transfer protocol request (HTTP) request. The caching can include caching the forwarder page on the client system. The caching can also include using HTTP headers and/or a cache manifest.

The operations can further include automatically enabling a back button function that will present a user with action options when the back button is pressed from the forwarding URL page display. The automatically enabling a back button function can include setting a timeout value for a first URL and then forwarding to a second URL after a timeout time period expires. The first URL can include an indication that the user is returning after having been automatically forwarded to another URL.

Another embodiment can include a system for aggregating web search results having a client system with a processor coupled to a computer readable data storage device. The data storage device can have program instructions stored therein that, when executed by the processor, cause the processor to perform operations.

The operations can include providing a user interface page for obtaining a web request for a first resource from a system external to the client system and extracting a URL fragment and user data from the web request. The operations can also include storing the user data in the data storage device of the client system and processing the URL fragment and the user data to produce processed data and identify a plurality of resources. The operations can further include generating a plurality of forwarding uniform resource locators (URLs) based on the processed data and making requests to each resource in the plurality of resources using the plurality of forwarding URLs.

The operations can also include receiving responses from each resource and aggregating the responses into a single result page. The operations can still further include directing a browser to the single result page.

Yet another embodiment can include a nontransitory computer readable medium having stored thereon software instructions that, when executed by a processor, cause the processor to perform operations. The operations can include providing a user interface page for obtaining a web request for a first resource from a system external to the client system and extracting a URL fragment and user data from the web request.

The operations can further include storing the user data on a data storage device of a client system and processing the URL fragment and the user data to produce processed data and identify a plurality of resources. The operations can also include generating a plurality of forwarding uniform resource locators (URLs) based on the processed data and making requests to each resource in the plurality of resources using the plurality of forwarding URLs.

The operations can still further include receiving responses from each resource, aggregating the responses into a single result page, and directing a browser to the single result page.

Either of the aggregating embodiments can include making requests using AJAX (Asynchronous JavaScript and XML). Also, either of the aggregating embodiments can include processing the URL fragment and the user data includes maintaining user data on the client system and not providing unprocessed user data to a system external to the client system.

The aggregating embodiments can also include aggregating the responses into a single page. For example, iframes (visible or invisible) can be used to show aggregated responses on a single page. Invisible iframes can be used as a way to embed a forwarder from a different domain/subdomain and can accept user data and respond with results using cross window messaging. A web worker can also be used, but may have some limitations, such as not being able to access local storage. The aggregating embodiments can further include a forwarding URLs directed to another aggregator and providing results by the other aggregator to include in the aggregated results.

### BRIEF DESCRIPTION OF THE DRAWINGS

FIG. 1 is a diagram of an exemplary web request forwarding system in accordance with at least one embodiment.

FIG. 2 is a diagram of an exemplary web request forwarding system with back button functionality in accordance with at least one embodiment.

FIG. 3 is a chart of an exemplary method for web request forwarding in accordance with at least one embodiment.

FIG. 4 is a diagram of an exemplary web request forwarder and result aggregator in accordance with at least one embodiment.

FIG. 5 is a diagram of an exemplary result page with aggregated results and nested aggregated results in accordance with at least one embodiment.

FIG. 6 is a diagram of an exemplary web request forwarder and/or aggregator in accordance with at least one embodiment.

FIG. 7 is a chart showing an exemplary method for web request forwarding and result aggregating in accordance with at least one embodiment.

### DETAILED DESCRIPTION

In general, an embodiment can include a web request forwarder in which processing associated with forwarding occurs on the client side. The web request forwarder can log the queries on client side.

An embodiment can also be used to create a router for web services. For example, a single web service can receive all the user requests send the user to an appropriate service depending upon the type of request being made. The system can send all search queries to the forwarder and the forwarder service will determine what search engine to use for it.

For example, a search query of “map Atlanta” can be forwarded to a mapping service (e.g., Google Maps, Rand McNally or the like). While a search query of “coffee shop Atlanta” can be forwarded to a local listing search engine or service. An embodiment can include client side processing that looks for keywords in queries to decide where to forward the query.

Alternatively, an embodiment can use more elaborate methods such as contacting the server based on need.

Another embodiment can include forwarding a request to multiple web pages. This can be achieved, for example, by loading multiple pages in frames in single page. Processing can occur on the client side before forwarding activates scripts from other servers.

An embodiment can include providing a webpage that acts as forwarder. The webpage can receive a user query as part of a URL fragment. The webpage can include javascript code that does some processing on the query and transforms it into a different query in some respect. The transformed user query can then be forwarded to another webpage.

For example, the forwarder webpage can be located at the following location:

http://www.example.com/forwarder.html. A user browser can send a query to the webpage in the following form: http://www.example.com/forwarder.html#querydata. When the webpage loads with the above URL, it checks for a URL fragment part (e.g., hash). Here, the URL fragment is “querydata.” A script inside the webpage can perform processing on “querydata” and transforms it to “transformed_querydata.”

After transformation, the script/webpage can forward the user to some other service, for example, http://www.otherservice.com/anywebpage?transformed_querydata.

An embodiment for forwarding the requests can include caching on user's browser agent, which can be implemented through the use of HTTP headers, for example, requesting the browser to cache this page for sufficient amount of time (e.g., a few days to a few weeks). Thus every request after first request need not be sent to the server. Also, in an embodiment, the browser can ignore a URL fragment part and treat requests as the same URL. Thus causing the browser to use a cached version of the page for every request.

Further, even when the browser sends a request to an external server because of cache expiry, the forwarder will not send URL fragment (e.g., user data) as part of the HTTP request (as per HTTP specification). Thus, the user data (e.g., “querydata”) will not leave user's computer (i.e., the client system).

Furthermore, the forwarder can have any custom logic in it with full capabilities of client side scripting. Thus it can forward request to different services based on user data or any other logic that can be programmed through javascript.

An embodiment can also include a browser with a built-in list of search providers, such that users can do searches directly from browser. A forwarder (and/or aggregator) in accordance with at least one embodiment can be part of that list along with any other search engine.

Also, for caching of forwarder on client side, a cache manifest can be used, which is part of the HTML5 specification.

In yet another embodiment, in addition to forwarding to another URL causing a page reload, an AJAX webpage can be employed that makes requests to a plurality of different resources (i.e. URLs/web services) on the web and combines the responses received to update a single result page. In other words, rather than forwarding a user browser to a single URL, a user can effectively make requests to multiple pages and have the responses displayed in single result page. This type of multiple request and combined result processing is sometimes referred to as a “mashup,” which includes integrating different services in single webpage.

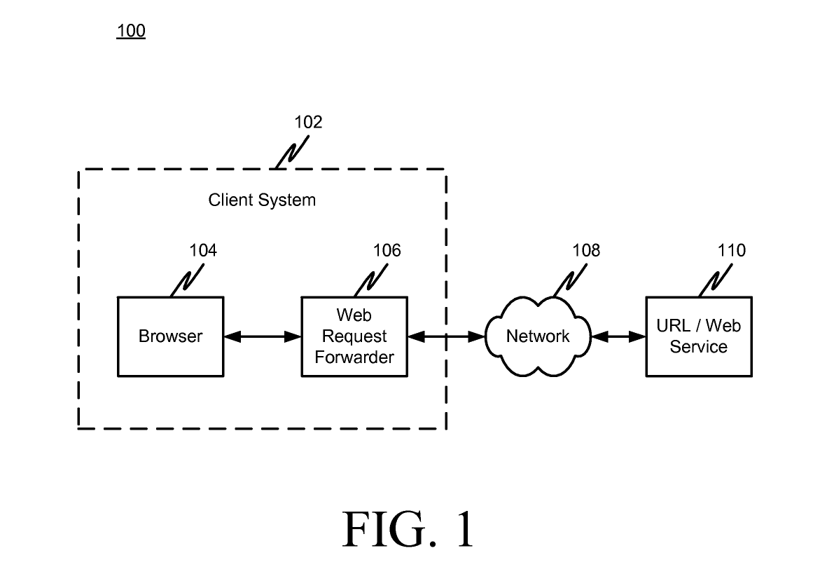

FIG. 1 shows an exemplary web request forwarding system 100 having a client system 102 with a browser 104 and a web request forwarder 106. The system 100 also includes a network 108 and at least one external URL/web service 110.

In operation, for example, a forwarder URL can be created such that a user data portion of a request is part of a URL fragment (also called a named anchor or hash). For example, a URL can have the following form: http://www.example.com/search#q=test+query. In this URL, the portion after the “#” symbol does not get sent to an external server in an HTTP request, and therefore remains private and doesn't leave the client system and client browser. Accordingly, user privacy can be protected.

Also, while caching, the URL fragment and/or user data is not used to identify the URL. That is, any change in the URL fragment does not constitute a change in the URL. A cached response can be used when there is change in the URL fragment.

The forwarder 106 can be established on the client system 102 and caching can be turned on for a forwarder page. The caching can be set to expire after a relatively long period of time such that all the forwarding requests within that time period do not create new HTTP requests to the server. For example, an expiration time can be set to 7 days, and after first request to the server there will no further request to the server for the next 7 days.

Caching can be done with HTTP headers or by using a cache manifest. When using headers, it may not be easy to clear the cache without a user manually clearing the browser cache. In the case of caching with headers, a special query such as “_CLEAR_CACHE” can be used. When the forwarder encounters this query (i.e., URL query fragment changed to include a fragment such as _CACHE_CLEARED or the like) it simply reloads the page using window.location.reload( ), which causes a page reload. Thus, to update cached forwarder the following URL http://www.example.com/forwarder1#_CLEAR_CACHE can be used, for example, in an invisible iframe and the forwarder will be reloaded from server.

For a cache manifest implementation, changing the cache manifest in some way can cause reloading on all files in manifest.

The forwarder page can have script code that executes when it loads. This script will do the processing on user data and take any action like editing the user supplied query, forwarding the user data to another service (URL/web service 110) via the network 108. The URL/web service 110 can itself be another forwarder.

This preprocessing can involve anything that client side script can perform. For example, http://www.example.com/search can have a script that will extract user data from the URL fragment and execute a processing script on it. After processing the forwarder 106 might forward the user to a different URL, such as http://some.search.engine.com?q=processed+user+data.

Alternatively, the forwarder 106 might forward the user to another web service depending on user data, such as: http://another.search.engine.com/search?q=processed+user+data. Because the forwarder page can be cached on the client system 102, a new user request does not necessarily require a server round trip. Thus, a lot of time can be saved and a forwarding delay can be reduced from around hundreds of milliseconds to a few milliseconds to tens of milliseconds depending on processing needed.

The forwarder 106 can also reduce or prevent the need to expose user data to an external server since forwarding processing is performed on the client system 102, thus helping to protect user privacy.

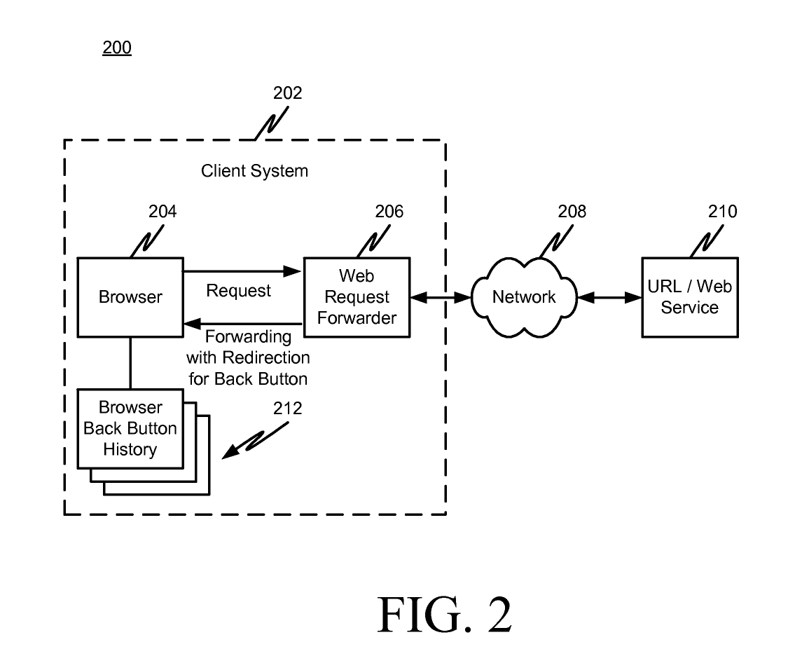

FIG. 2 shows an exemplary web request forwarding system 200 having a client system 202 with a browser 204, a web request forwarder 206 and browser back button history 212. The system 100 also includes a network 208 and at least one external URL/web service 210.

In addition to the forwarding operation described above with respect to FIG. 1, the forwarder 206 can also include browser back button functionality that permits a user to come back to the forwarder 206 after the user has been automatically forwarded to the external URL/web service 210 by the forwarder 206.

In operation, after forwarding, the user can click the “back button” of the browser 204. Clicking the back button will take user back to the forwarder 206, where user can chose an action to take. The set up of the back button functionality occurs automatically with no interaction on the part of user required.

For example, http://www.example.com/search?q=test+query can take the user immediately without any action on part of user to the following page:

http://some.search.engine.com/search?q=processed+query. On this page the back button is enabled.

The back button behavior can be achieved by using special redirection so that back button remains enabled even when user is forwarded to another page automatically.

This special redirection can be implemented, for example, by using the setTimeout facility of javascript. The setTimeout function can have a timeout set to 0 milliseconds and execute a redirection action on timeout. This enables the back button functionality even though redirection occurred automatically.

Redirection can include more than just changing the URL to destination page URL. For example, redirection can include changing the URL fragment to signal that forwarding has been done. When the user presses the back button on the browser 204, the page reloading can detect that forwarding has already happened and need not forward again and user has come to this page by pressing the back button.

For example, http://www.example.com/search#test+query can execute setTimeout(0, “redirectAfterModifyingURLFragment( )”); thus first forwarding user to a first page, e.g.

http://www.example.com/search#forwarded=true&q=test+query, and then to a second page, e.g., http://some.search.engine.com/search?q=processed+query.

The URL of the first page can be placed into the browser back button history 212. When the user is on the second page and if he presses back button which should be enabled, he will be taken to http://www.example.com/search#forwarded=true&q=test+query.

The script on this page will see that the parameter “forward” has been set to a value of “true”, and will therefore not forward user but will present the user with choices as to what action needs to be taken (e.g., forwarding to another service).

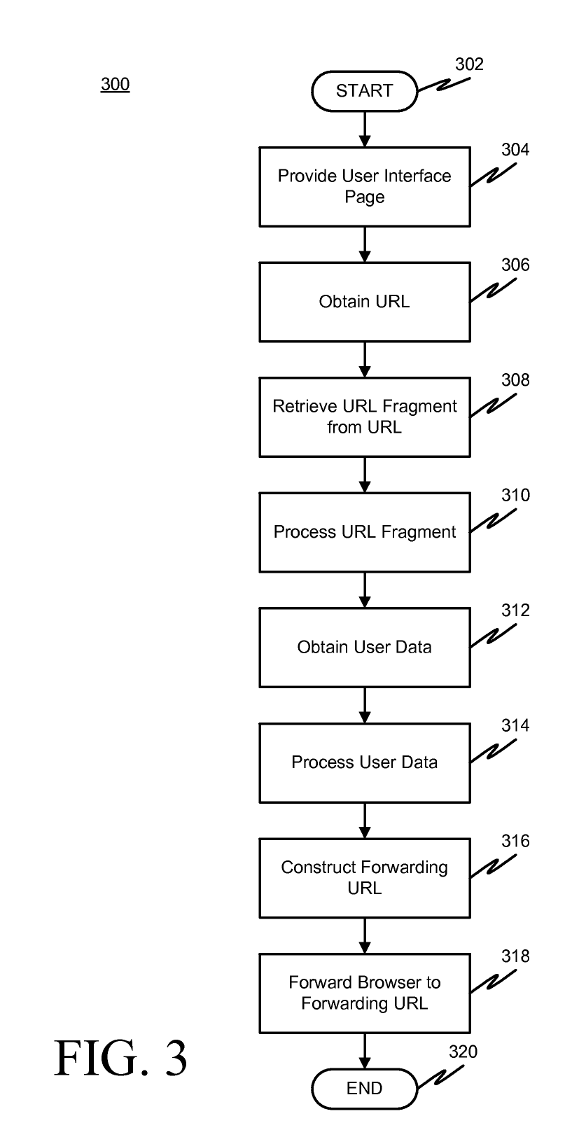

FIG. 3 is a chart of an exemplary method (or process) 300 for web request forwarding in accordance with at least one embodiment. Processing begins at 302 and continues to 304.

At 304, a user interface page is provided. For example, a landing page or search provider can be created for display in a browser that will accept queries from user send them to a URL having a predetermined form, for example http://www.example.com/search#user+supplied+data. A user interface page located at http://www.example.com/search. On the forwarding server on the client side, a response header can be set such that it requests the client browser agent to cache the response for a reasonably long time (e.g., 7 days). Upon loading, the interface page can reference a client-side script that can perform processing upon page loading. Processing continues to 306.

At 306, a user request URL is obtained. Processing continues to 308.

At 308, a URL fragment is retrieved (or extracted) from the URL. The URL fragment can include a portion of the URL. Processing continues to 310.

At 310, the URL fragment is processed. Processing continues to 312. At 312, user data is obtained. Processing continues to 314. At 314, the user data is processed. Processing continues to 316. At 316, a forwarding URL is constructed based on the URL, the URL fragment and/or the processed user data. Processing continues to 318.

At 318, the browser window location is changed to the forwarding URL. Processing continues to 320 where processing ends.

Optionally, the forwarding action can be modified by the user after the user presses the “back button” on the browser. This optional functionality can include testing if a forwarded flag is set, not set or is false. Also, a timeout can be set for 0 seconds and function to execute on timeout can be defined to change a URL fragment to set the forwarded flag to a value of “true”, and then to change browser window to the URL to forward to 4. Otherwise, if the forwarded flag is already set to a value of “true”, presenting the user with an option to take an alternate action (e.g., forwarding to a different URL/web service).

It will be appreciated that 302-320 can be repeated in whole or in part in order to accomplish a contemplated request forwarding/aggregating task.

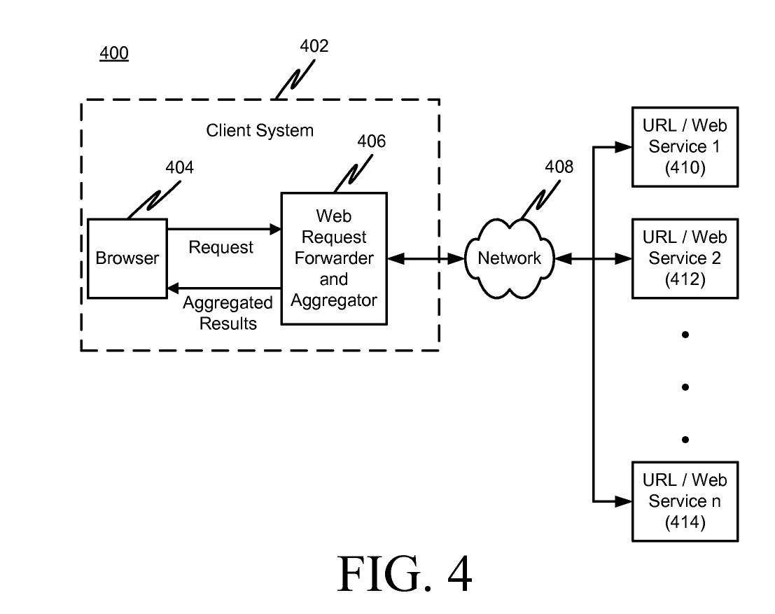

FIG. 4 shows an exemplary web request forwarding system 400 having a client system 402 with a browser 404 and a web request forwarder/aggregator 406. The system 400 also includes a network 408 and a plurality of external URL/web services (410-414).

In operation, the forwarder/aggregator 406 can function as a search aggregator, for example. The forwarder/aggregator 406 can maintain a user's privacy and provide for dynamic selection of services to use based on one or more of a user's query data, a URL, or a URL fragment or other data.

The forwarder/aggregator 406 can thus act as search engine which accepts a user's search queries and sends it to selection of services.

For example, when the user queries for some search term, the forwarder/aggregator can select a list of service providers that have been determined to be suited to help serve the request.

For example, queries related to video search may be best served by a video search engine such as Youtube.com. Processing the user's request for selection of services to use can be done with help of offline storage in web browser and/or with a list of keywords stored in an offline storage or regular expressions.

Offline storage can include cookies, local storage, a database, or the like. User queries need not be sent to an external server for selection of services to use. Thus, helping to avoid network delay and to protect privacy.

For example, a user sends a request to a forwarder/aggregator located at http://www.example.com/forwarder.htm#ruby%20videos. The forwarder/aggregator then processes the query “ruby videos” and, using a list of keywords from offline storage, determines that this is a query for videos. Here, the presence of the term “videos” in search query suggest that the query can be served by the Youtube search API. Accordingly, the requests will be sent to the included forwarder using URL fragment as described above or sent using cross document messaging (e.g., cross window messaging.) The included forwarder can respond using cross window messaging as well.

In another example, a forwarder/aggregator hosted on www.facebook.com can access a user's data from facebook as it will have access to cookies and offline storage associated with that domain. The forwarder/aggregator can also send requests to facebook.com without cross domain AJAX limitation. Nesting that forwarder in another page can permit a parent page to send requests to this forwarder and access data from facebook.com. Also, the forwarder/aggregator can let the page access the user's data on per request basis.

In general, an embodiment provides a search engine that aggregates data from different web services. It can do this while remaining offline. It can dynamically select services to use for forwarding/aggregating. It can send AJAX requests to different services for searching. It can also use nested forwarders to use user's data from other services or divide work among different forwarders. It will then use data returned from AJAX requests and forwarders to show user search results tailored to the user's preferences.

The term “forwarder” as used herein can also refer to a router, since the forwarder may not simply forward the request, but may perform some processing on a user's request and can respond to requests on its own.

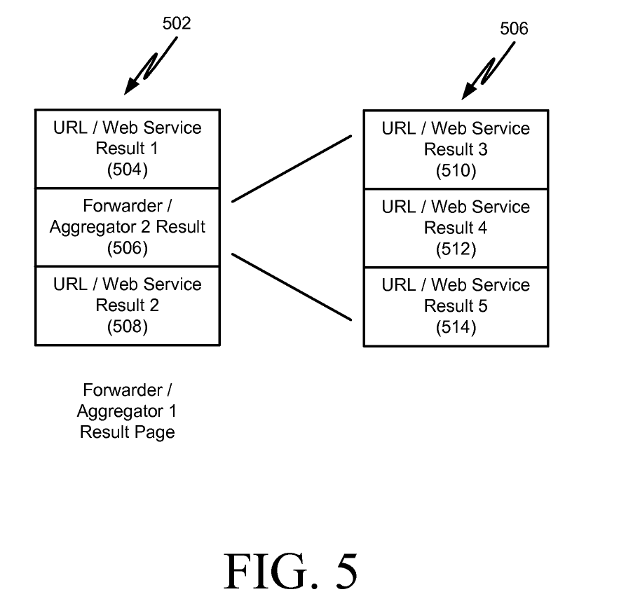

FIG. 5 is a diagram of an exemplary aggregated result page 502. The aggregated results page includes results from a first URL/web service 504, results from a second aggregator 506 and results from a second URL/web service 508. The aggregated results from the second aggregator 506 include results from a third URL/web service 510, results from a fourth URL/web service 512 and results from a fifth URL/web service 514.

Thus, a forwarder can be “nested” inside a webpage or another forwarder. For example, a forwarder can be included in another page (which can be another forwarder) using iframes (visible or invisible) or a web worker. A nested forwarder need not be from the same domain and the nested forwarder can aggregate data from different websites.

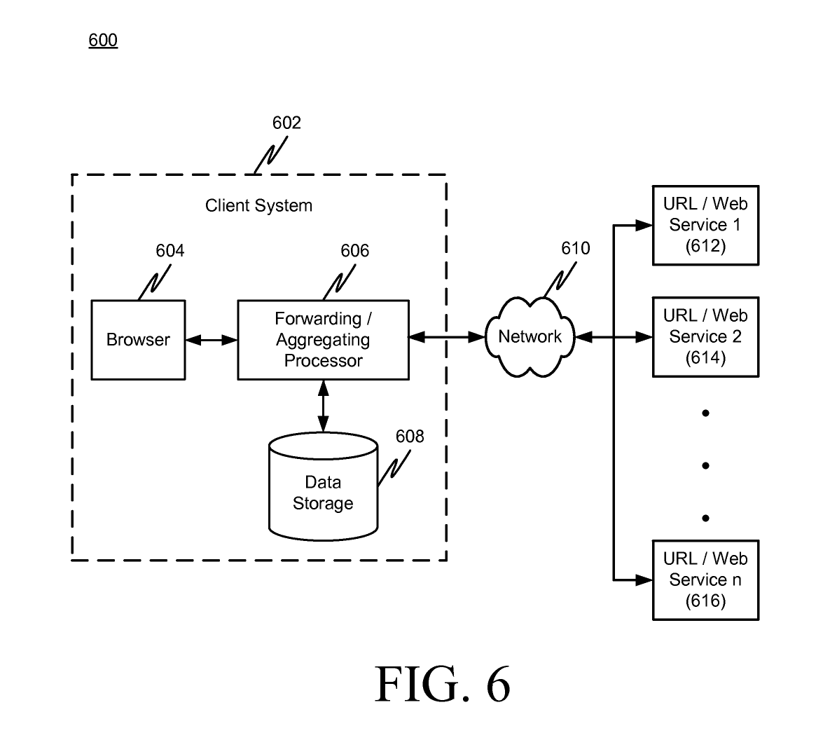

FIG. 6 is a diagram of an exemplary web request forwarder and/or aggregator system 600. The system 600 includes a client system 602 having a browser 604, a forwarding/aggregating processor 606 and a data storage 608 (e.g., offline storage). The system 600 also includes a network 610 and a plurality of URL/web services (612-616).

In operation, the system 600 can function similar to the system 400 described above. However, in the system 600 the forwarder 606 can use an offline storage 608 as well as sending requests to external web resources (612-616) or include another forwarder as well. In other words, the forwarding/aggregating processor 606 can be a full fledged forwarder with all the capabilities described above. The offline storage can be used to store a one way hash of keywords using, for example, CRC32 or the like on the client system. The user's query and/or parts of the query can be compared to hashed keywords using a one way hash. The forwarding/aggregating server can store important data on the client system without fully exposing it to the client. For example, a list of keywords that should match to identify a type of query can be important to some businesses and these businesses may not want a competitor easily obtaining the list. Also, using hashed keywords can reduce a storage space requirement on the client system.

An embedded (or nested) forwarder can communicate to a parent forwarder using cross window messaging (or message passing meant for web workers). It can send a response using cross window messaging as well. Also, sub-domains can be used to host different forwarders and each forwarder can use offline storage to determine whether to respond to a query or not. Alternatively, a forwarder can forward the request using AJAX and returns the response to parent window.

Also, there can be dependency between nested forwarders such that response of one forwarder can be used by another forwarder, and one can wait until the other forwarder responds. For example, there can be a forwarder which will be dependent upon another forwarder returning web search results and it will massage those search results with additional information. Or, there can be a forwarder which will use query data and detect location of the query and location dependent forwarders will depend upon this forwarder to give location specific information.

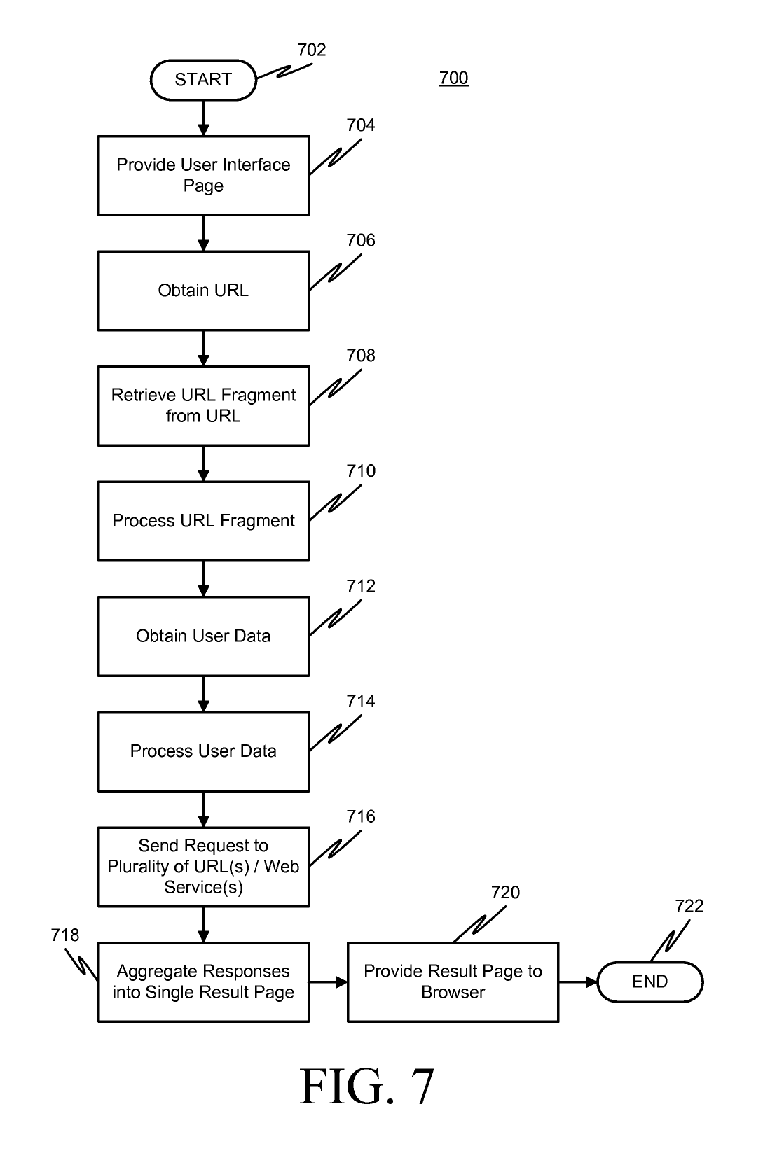

FIG. 7 is a chart showing an exemplary computerized method (or process) 700 for web request forwarding and result aggregating. Processing begins at 702 and continues to 704.

At 704, a user interface page is provided. For example, a landing page or search provider can be created for display in a browser that will accept queries from user send them to a URL having a predetermined form, for example http://www.example.com/search#user+supplied+data. A user interface page located at http://www.example.com/search. On the forwarding server on the client side, a response header can be set such that it requests the client browser agent to cache the response for a reasonably long time (e.g., 7 days). Upon loading, the interface page can reference a client-side script that can perform processing upon page loading. Processing continues to 706.

At 706, a user request URL is obtained. Processing continues to 708. At 708, a URL fragment is retrieved (or extracted) from the URL. The URL fragment can include a portion of the URL. Processing continues to 710.

At 710, the URL fragment is processed. Processing continues to 712. At 712, user data is obtained. Processing continues to 714.

At 714, the user data is processed. The processing can include accessing an offline storage to retrieve word lists or other data or programs to help determine a list of the suitable URLs/web services to send the request to. Processing continues to 716.

At 716, requests are sent to a plurality of URLs/web services based on the list developed in 714. The requests can be sent using AJAX requests, for example. Processing continues to 718.

At 718, responses from the requests are collected and aggregated into a single result page using, for example, iframes (visible or invisible), web workers, or the like. Processing continues to 720. At 720, the combined results page is provided to the browser. Processing continues to 722, where processing ends. It will be appreciated that 702-722 can be repeated in whole or in part in order to accomplish a contemplated request forwarding/aggregating task.

It will be appreciated that the modules, processes, systems, and sections described above can be implemented in hardware, hardware programmed by software, software instructions stored on a nontransitory computer readable medium or a combination of the above. A system for web request forwarding and/or result aggregating can be implemented, for example, using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like, or a scripting language such as javascript, php or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer readable media may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the user interface, web and/or computer programming arts.

Moreover, embodiments of the disclosed method, system, and computer readable media can be implemented in software executed on a programmed general purpose computer, a special purpose computer, a microprocessor, or the like.

It is, therefore, apparent that there is provided, in accordance with the various embodiments disclosed herein, systems, methods and computer readable media for web request forwarding and result aggregating.

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

What is claimed is:

1. A system for forwarding web requests, the system comprising:
a client system having a processor coupled to a computer readable data storage device;
the data storage device having program instructions stored therein that, when executed by the processor, cause the processor to perform operations including:
providing a user interface page for obtaining a web request for a first resource residing on a system external to the client system;
obtaining a uniform resource locator (URL) from the web request;
retrieving a URL fragment from the URL;
processing the URL fragment;
obtaining user data from the web request;
processing the user data;
constructing a forwarding URL; and
directing a web browser program to the forwarding URL, the forwarding URL constructed to access a second resource from a system external to the client system.

2. The system of claim 1, wherein the user data remains within the client system and is not transmitted to a system external to the client system.

3. The system of claim 1, wherein processing the user data includes processing the user data with a client-side script.

4. The system of claim 1, wherein the operations further include enabling caching on a forwarder page such that requests within a predetermined time period do not create a new hypertext transfer protocol request (HTTP) request.

5. The system of claim 4, wherein the caching includes caching the forwarder page on the client system.

6. The system of claim 5, wherein the caching includes using one of HTTP headers and a cache manifest.

7. The system of claim 5, wherein the cache can be cleared using a predetermined query.

8. The system of 1, wherein the operations further include automatically enabling a back button function that will present a user with action options when the back button is pressed from the forwarding URL page display.

9. The system of claim 8, wherein the automatically enabling the back button function includes setting a timeout value for a first URL and then forwarding to a second URL after a timeout time period expires.

10. The system of claim 9, wherein the first URL includes an indication that the user is returning after having been automatically forwarded to another URL.

11. A system for aggregating web search results, the system comprising:
a client system having a processor coupled to a computer readable data storage device,
the data storage device having program instructions stored therein that, when executed by the processor, cause the processor to perform operations including:
providing a user interface page for obtaining a web request for a first resource from a system external to the client system;
extracting a URL fragment and user data from the web request;
storing the user data in the data storage device of the client system;
processing the URL fragment and the user data to produce processed data and identify a plurality of resources;
generating a plurality of forwarding uniform resource locators (URLs) based on the processed data;
making requests to each resource in the plurality of resources using the plurality of forwarding URLs;
receiving responses from each resource;
aggregating the responses into a single result page; and
directing a browser to the single result page.

12. The system of claim 11, wherein making requests includes using AJAX to make the requests.

13. The system of claim 11, wherein processing the user data includes comparing at least a portion of a user query to hashed data stored on the client system.

14. The system of claim 11, wherein aggregating the responses into a single page includes one of providing visible iframes on the single page, providing invisible iframes on the single page and using a webworker.

15. The system of claim 11, wherein one of the forwarding URLs is to another aggregator and results provided by the other aggregator include aggregated results.

16. A nontransitory computer readable medium having stored thereon software instructions that, when executed by a processor, cause the processor to perform operations comprising:
providing a user interface page for obtaining a web request for a first resource from a system external to the client system;
extracting a URL fragment and user data from the web request;
storing the user data on a data storage device of a client system;
processing the URL fragment and the user data to produce processed data and identify a plurality of resources;
generating a plurality of forwarding uniform resource locators (URLs) based on the processed data;
making requests to each resource in the plurality of resources using the plurality of forwarding URLs;
receiving responses from each resource;
aggregating the responses into a single result page; and
directing a browser to the single result page.

17. The computer readable medium of claim 16, wherein making requests includes using AJAX to make the requests.

18. The computer readable medium of claim 16, wherein the processing the URL fragment and the user data includes maintaining user data on the client system and not providing unprocessed user data to a system external to the client system.

19. The computer readable medium of claim 16, wherein aggregating the responses into a single page includes one of providing visible iframes on the single page, providing invisible iframes on the single page and using a webworker.

20. The computer readable medium of claim 16, wherein one of the forwarding URLs is to another aggregator and results provided by the other aggregator include aggregated results.
